(19) United States
(12) Patent Application Publication
(10) Pub. No.: US 2017/0041652 A1
(43) Pub. Date: Feb. 9, 2017

(54) IMAGE DATA PROCESSING METHOD AND ELECTRONIC DEVICE SUPPORTING THE SAME

(71) Applicant: Samsung Electronics Co., Ltd., Gyeonggi-do (KR)

(72) Inventors: Bong Hyuck KO, Jeju-do (KR); Han Sang KIM, Seoul (KR); Hyung Suk KIM, Gyeonggi-do (KR); Kwan Woong SONG, Gyeonggi-do (KR)

(21) Appl. No.: 15/214,831

(22) Filed: Jul. 20, 2016

(30) Foreign Application Priority Data
Aug. 7, 2015 (KR) 10-2015-0111709

(51) Int. Cl. H04N 21/2662; H04N 19/124; H04N 19/117; H04N 19/80; H04N 19/86

(52) U.S. Cl. CPC H04N 21/2662; H04N 19/80; H04N 19/86; H04N 19/117; H04N 19/124

(57) ABSTRACT

An electronic device comprising: a communication circuit; a memory; and at least one processor operatively coupled to the memory, configured to: acquire image data; identify a data transmission rate; in response to detecting that the data transmission rate fails to meet a threshold, apply a filter to the image data to generate filtered data, wherein the filter removes a portion of the image data that is associated with a given frequency band; and transmitting the filtered data to an external device by using the communication circuit.

### CLAIM OF PRIORITY

This application claims the benefit under 35 U.S.C. §119(a) of a Korean patent application filed on Aug. 7, 2015 in the Korean Intellectual Property Office and assigned Serial number 10-2015-0111709, the entire disclosure of which is hereby incorporated by reference.

### TECHNICAL FIELD

The present disclosure relates to electronic devices, in general, and more particularly to a method of processing image data and an electronic device supporting the same.

### BACKGROUND

An electronic device supports image data processing. For example, the electronic device includes a camera and stores image data that the camera collects. Furthermore, the electronic device sends the image data, which is stored in a memory, to another electronic device.

Meanwhile, with regard to a resource-constrained environment in which a network bandwidth decreases or an environment to which a storage space in which image data is stored is limited, a conventional electronic device uses a method of decreasing the image quality by reducing the size of an image or deleting a portion of image data. Among conventional methods, the image size reducing scheme makes it difficult to store or send an image of which the size is required by a user. Moreover, the image quality decreasing scheme causes an error associated with coding, and thus a subjective image quality is reduced, for example, a blocking artifact is generated.

### SUMMARY

According to aspects of the disclosure, an electronic device is provided comprising: a communication circuit; a memory; and at least one processor operatively coupled to the memory, configured to: acquire image data; identify a data transmission rate; in response to detecting that the data transmission rate fails to meet a threshold, apply a filter to the image data to generate filtered data, wherein the filter removes a portion of the image data that is associated with a given frequency band; and transmitting the filtered data to an external device by using the communication circuit.

According to aspects of the disclosure, a method is provided comprising: acquiring image data; identifying a data transmission rate; in response to detecting that the data transmission rate fails to meet a threshold, applying a filter to the image data to generate filtered data, wherein the filter removes a portion of the image data that is associated with a given frequency band; and transmitting the filtered data to an external device by using a communication circuit.

According to aspects of the disclosure, a non-transitory computer readable medium is provided storing one or more processor-executable instructions which, when executed by at least one processor, cause the at least one processor to perform a method comprising: acquiring image data; identifying a data transmission rate; in response to detecting that the data transmission rate fails to meet a threshold, applying a filter to the image data to generate filtered data, wherein the filter removes a portion of the image data that is associated with a given frequency band; and transmitting the filtered data to an external device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram of an example of a data transmission environment, according to an embodiment;

FIG. 2 is a diagram of an example of an electronic device, according to an embodiment;

FIG. 3A is a diagram of an example of a processor, according to an embodiment;

FIG. 3B is a graph illustrating an example of an RD model, according to an embodiment;

FIG. 3C is a graph illustrating an example of a plurality of RD models, according to an embodiment;

FIG. 4 is a flowchart of an example of a process, according to an embodiment;

FIG. 5 is a flowchart of an example of a process, according to an embodiment;

FIG. 6 is diagram of an example of an electronic device, according to an embodiment;

FIG. 7 is a diagram of an example of a user interface, according to an embodiment;

FIG. 8 is a diagram of an example of an electronic device, according to an embodiment; and

FIG. 9 is a diagram of an example of a program module, according to an embodiment.

Throughout the drawings, it should be noted that like reference numbers are used to depict the same or similar elements, features, and structures.

### DETAILED DESCRIPTION

Various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present invention. With regard to description of drawings, similar elements may be marked by similar reference numerals.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments, but do not limit the elements. For example, “a first user device” and “a second user device” may indicate different user devices regardless of the order or priority thereof. For example, “a first user device” and “a second user device” may indicate different user devices. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening elements (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. CPU, for example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one software program which are stored in a memory device.

Terms used in the present disclosure are used to describe specified embodiments and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art of the present disclosure. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, e-book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

Hereinafter, electronic devices according to various embodiments will be described with reference to the accompanying drawings. The term “user” used herein may refer to a person who uses an electronic device or may refer to a device (e.g., an artificial intelligence electronic device) that uses an electronic device.

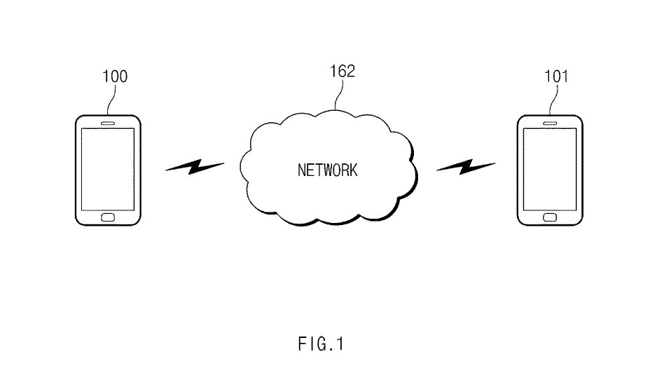

FIG. 1 is a diagram of an example of a data transmission environment, according to an embodiment. As illustrated, the image data transmission environment may include an electronic device 100, an external electronic device 101, and a network 162.

In the image data transmission environment, when storing image data or sending image data, the electronic device 100 may perform image pre-processing based on a target bitrate (e.g., a target bitrate smaller than a bitrate of the stored image data or a target bitrate in which the image data is sent according to a bandwidth relatively smaller than a designated network bandwidth) of a designated condition. In this operation, on the basis of a characteristic (e.g., frequency components of pixels included in an image) of an image, the electronic device 100 may select an optimal frequency that is applied to a low band (or a low frequency band) or may select a mask filter coefficient to apply the selected result to the image. The optimal frequency may include information about a threshold value corresponding to a low frequency in the process of filtering a frequency by a low pass filter. The mask filter coefficient may correspond to a specific value to be applied to a filter in a spatial domain corresponding to the optimal frequency. As such, the electronic device 100 may decrease the amount (or size) of data belonging to a relatively high frequency band by allocating a few bits to a high frequency band in a quantization operation with respect to image data (e.g., reducing a bit allocating ratio of a high frequency band) or may increase the amount (or size) of data belonging to a relatively low frequency band by allocating a lot of bits to a low frequency band therein, thereby improving an image quality. As such, the electronic device 100 may minimize a blocking artifact to store or send (or transmit) image data of the improved subjective evaluation image quality.

The network 162 may establish a communication channel between the electronic device 100 and the external electronic device 101. The network 162 may include various wireless environments. Accordingly, a network bandwidth to be allocated to the electronic device 100 in an environment in which the electronic device 100 sends (or transmits) image data may be changed. Alternatively, the network bandwidth to be allocated to the electronic device 100 may be negotiated when the communication channel is established. In this regard, the network 162 may include a base station and the like. The base station may negotiate a channel characteristic of network communication with the electronic device 100 or the external electronic device 101 and send data through the negotiated communication channel. Moreover, if a network wireless environment is changed (e.g., if the number of network users is greater than or equal to a specific value of a designated condition or if the network bandwidth is limited according to needs), the base station may change the network bandwidth for communication with the electronic device 100 or the external electronic device 101. The network 162 may send image data, which the electronic device 100 sends, to the external electronic device 101 and the like.

The external electronic device 101 may receive the image data that the electronic device 100 sends. According to various embodiments, the external electronic device 101 may receive data including at least one of image data and sound data or text data. The external electronic device 101 may output the received image data to a display. In this operation, the external electronic device 101 may output the image data, which the electronic device 100 sends in a streaming manner, in real time.

The electronic device 100 may change a target bitrate based on the change in a processing environment (e.g., a network bandwidth or a storage space) of the image data and perform image pre-processing for applying an optimal frequency or mask filter coefficient suitable for the changed target bitrate to a low pass filter that is associated with the image data to be sent or stored. The electronic device 100 may encode the pre-processed data and store the encoded image data in a memory or send the encoded image data to the network 162.

According to an embodiment, the electronic device 100 may determine (or detect, or verify) an effective network bandwidth (or valid network bandwidth) associated with image data transmission. The electronic device 100 may calculate a target bitrate suitable for the effective network bandwidth and apply the calculated target bitrate and an optimal frequency (or a threshold frequency) or mask filter coefficient suitable for the characteristic of an image to be sent to the low pass filter. In this operation, the electronic device 100 may perform image pre-processing by using an adaptive prefilter applying the optimal frequency to the low pass filter (or applying a mask filter coefficient corresponding to the optimal frequency to a low pass filter). After encoding the pre-processed data, the electronic device 100 may provide the encoded data to the designated external electronic device 101 through the network 162.

Moreover, when image data is collected and stored, the electronic device 100 may detect the change of a storage space of a memory. If the amount of free space in the memory is less than or equal to a predetermined threshold, the electronic device 100 may perform a process for securing an effective storage space (or valid storage space). For example, the electronic device 100 may select an optimal frequency suitable for the characteristic of the obtained image and a target bitrate of data to be stored, may encode the pre-processed data based on the selected optimal frequency, and may store the encoded data in a memory. Alternatively, the electronic device 100 may select a mask filter coefficient suitable for a target bitrate, may encode the pre-processed data based on the selected mask filter coefficient, and may store the encoded data in a memory.

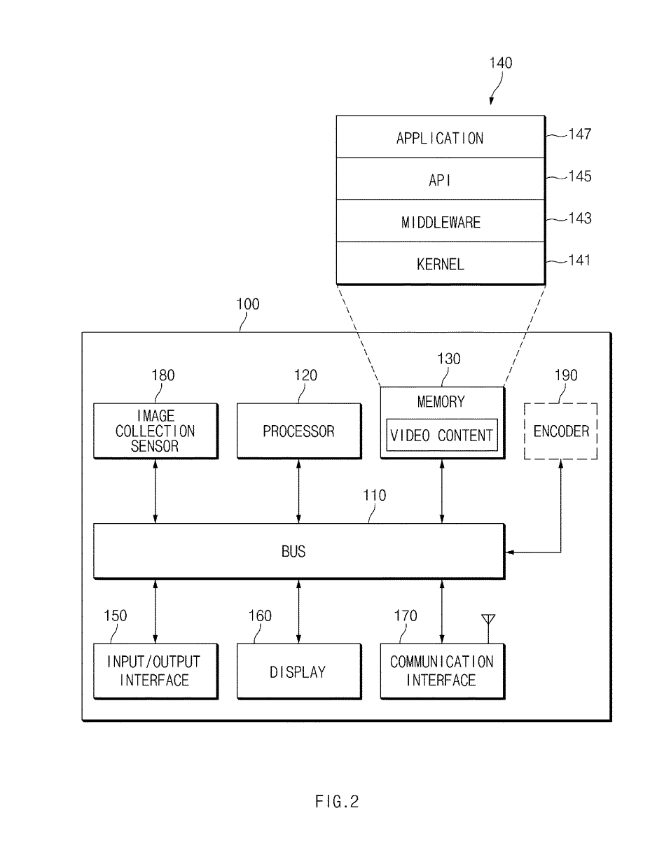

FIG. 2 is a diagram of an example of an electronic device, according to an embodiment. As illustrated, the electronic device 100 may include a bus 110, a processor 120, a memory 130, an input/output interface 150, a display 160, a communication interface 170, an image collection sensor 180, and an encoder 190.

The above-described electronic device 100 may perform image pre-processing based on an adaptive prefilter in which an optimal frequency is applied to image data according to the change of an environment in which sensed (or detected) data is processed.

The bus 110 may interconnect the above-described elements 120 to 190 and may be a circuit for conveying communications (e.g., a control message and/or data) among the above-described elements. For example, the bus 110 may connect the communication interface 170 with the memory 130. The bus 110 may send image data stored in the memory 130 to the communication interface 170. Moreover, the bus 110 may connect the image collection sensor 180 with the memory 130. The bus 110 may send image data, which the image collection sensor 180 collects, to the processor 120. Moreover, the bus 110 may send image data, which is pre-processed by the processor 120 and is encoded by the encoder 190, to the memory 130. According to various embodiments, the encoder 190 may be implemented in the form of hardware or software. For example, the encoder 190 may be implemented in the processor 120, with a separate hardware element, or in the memory 130.

The processor 120 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In operation, the processor 120 may perform an arithmetic operation or data processing associated with control and/or communication of at least other elements of the electronic device 100. According to an embodiment, the processor 120 may perform at least one of an operation of detecting the storage space of the memory 130 based on a function that is operating or an operation of detecting an available bandwidth according to a network wireless environment. For example, when operating the image collection sensor 180, the processor 120 may detect the storage space of the memory 130. Alternatively, when operating the communication interface 170, the processor 120 may detect an available bandwidth according to a network wireless environment. The processor 120 may calculate a target bitrate based on the verified information. On the basis of the characteristic of image data to be stored or to be sent or the target bitrate, the processor 120 may calculate and apply an optimal frequency or may calculate and apply a mask filter coefficient. For example, the characteristic of the image data may include the distribution shape of a frequency component included in the image data. For example, the characteristic of image data may include information about how much a designated high frequency component (or a designated low frequency component) is distributed in the image data, information about the density or the dispersion of the high frequency component (or low frequency component) or the like. The processor 120 may perform image pre-processing such that the calculated optimal frequency (or mask filter coefficient) is applied to a low pass filter. The processor 120 may send the pre-processed data to the encoder 190.

The memory 130 may include any suitable type of volatile or non-volatile memory, such as Random-access Memory (RAM), Read-Only Memory (ROM), Network Accessible Storage (NAS), cloud storage, a Solid State Drive (SSD), etc. The memory 130 may include a volatile and/or a nonvolatile memory. The memory 130 may store, for example, an instruction or data associated with at least one other element(s) of the electronic device 100. The instruction may be executed by the processor 120. The instruction may include, for example, an instruction for determining the amount of free space in the memory 130, an instruction configured to detect an available network bandwidth, a target bitrate calculation instruction, an instruction for applying an optimal frequency (or mask filter coefficient) corresponding to a calculated target bitrate or the like.

According to various embodiments, the memory 130 may store video content. At least a part of the video content may include image data. The video content may include, for example, image data collected through the image collection sensor 180. At least a part of the video content may include, for example, the pre-processed image data belonging to a low band based on an optimal frequency (a frequency of threshold value configured to minimize a blocking artifact) or mask filter coefficient (a filter coefficient configured to minimize the blocking artifact) selected according to a designated target bitrate. According to various embodiments, the video content may include image data sent to the network 162 through the communication interface 170. For example, the video content may be encoded after image pre-processing is performed with respect to a low band of an image based on the optimal frequency or mask filter coefficient selected according to the designated target bitrate, and the encoded image content may be sent to the network 162.

According to various embodiments, the memory 130 may store software and/or a program 140. The program 140 may include, for example, a kernel 141, a middleware 143, an application programming interface (API) 145, and/or an application program (or an application) 147. At least a portion of the kernel 141, the middleware 143, or the API 145 may be called an “operating system (OS)”.

For example, the kernel 141 may control or manage system resources (e.g., the bus 110, the processor 120, the encoder 190, the image collection sensor 180, or the memory 130, and the like) that are used to execute operations or functions of other programs (e.g., the middleware 143, the API 145, and the application program 147). Furthermore, the kernel 141 may provide an interface that allows the middleware 143, the API 145, or the application program 147 to access discrete elements of the electronic device 100 so as to control or manage system resources.

The middleware 143 may perform a mediation role such that the API 145 or the application program 147 communicates with the kernel 141 to exchange data. Furthermore, the middleware 143 may process task requests received from the application program 147 according to a priority. For example, the middleware 143 may assign the priority, which makes it possible to use a system resource (e.g., the bus 110, the processor 120, the encoder 190, the image collection sensor 180, the memory 130, or the like) of the electronic device 100, to at least one of the application program 147. For example, the middleware 143 may process the task requests according to the priority assigned to the at least one, which makes it possible to perform scheduling or load balancing on the task requests.

The API 145 may include, for example, an interface for controlling a function provided by the kernel 141 or the middleware 143. The API 145 may include, for example, at least one interface or function (e.g., an instruction) for a file control, a window control, image processing, a character control, or the like.

The application 147 may include, for example, at least one application. For example, the application may include a music application, a workout (or a healthcare) application, an alarm application, or the like. According to an embodiment, the application 147 may include a video content storage application or a video content streaming application. The video content storing application may include a video collection function of the image collection sensor 180. If an image is collected, the video content storing application may provide an image collection time extending function based on the amount of remaining free space in the memory 130. The video content streaming application may perform a streaming service of video content. If a network bandwidth is changed while sending image data, the video content streaming application may change a target bitrate and may perform image pre-processing including low band processing with respect to an image in which a low frequency component in a specific low frequency band is great (or high band processing with respect to an image in which a high frequency component in the specific high frequency band decreases to be smaller than the high frequency component of the previous image data). After the pre-processed data is encoded, a video content streaming application may send the encoded data to a designated device (e.g., an external electronic device or the like) through the network 162.

The I/O interface 150 may transmit an instruction or data, input from a user or another external device, to other element(s) of the electronic device 100. Furthermore, the input/output interface 150 may output an instruction or data, received from other element(s) of the electronic device 100, to a user or another external device. For example, the input/output interface 150 may include at least one of a physical button, a touch button, a touch pad, a touch screen, or the like. Moreover, the input/output interface 150 may include an input mean by an electronic pen or the like. Moreover, the input/output interface 150 may include an audio device processing an audio signal. The audio device may output audio data associated with the execution of an application. The above-described audio data outputting function may be omitted according to the setting of a user or according to inputting by a user.

According to an embodiment, if the amount of free space in the memory 130 is smaller than or equal to a designated threshold, the input/output interface 150 may generate an input event associated with the execution of the image collection time extending function. In this regard, the electronic device 100 may output at least one virtual button associated with the image collection time extending function.

The display 160 may include, for example, a liquid crystal display (LCD), a light-emitting diode (LED) display, an organic LED (OLED) display, a microelectromechanical systems (MEMS) display, or an electronic paper display. The display 160 may display, for example, various content (e.g., a text, an image, a video, an icon, a symbol, or the like) to a user. The display 160 may include a touch screen and may receive, for example, a touch, gesture, proximity, or hovering input using an electronic pen or a part of a user's body.

The display 160 may output, for example, a screen associated with the operation of the image collection sensor 180. If the amount of free space in the memory 130 is smaller than or equal to the designated threshold when an image is collected and stored, the display 160 may output a popup window for asking whether to execute an image collection time extending function under the control of the processor 120. While an image collection function is executed, the display 160 may output a preview screen or the like. According to various embodiments, the display 160 may output a streaming service screen through the network 162. Under control of the processor 120, the display 160 may output guide information about the change of an available network bandwidth, guide information about transmission of image data in the changed available network bandwidth, and the like during a streaming service.

For example, the communication interface 170 may establish communication between the electronic device 100 and the network 162 and between the electronic device 100 and an external electronic device 101. The communication interface 170 may support wireless communication, wired communication, or the like. The wireless communication may include at least one of, for example, a long-term evolution (LTE), an LTE Advance (LTE-A), a code division multiple access (CDMA), a wideband CDMA (WCDMA), a universal mobile telecommunications system (UMTS), a wireless broadband (WiBro), a global system for mobile communications (GSM), or the like, as a cellular communication protocol. Furthermore, the wireless communication may include, for example, a local area network. The local area network may include at least one of, for example, a wireless fidelity (Wi-Fi), a Bluetooth, a near field communication (NFC), a magnetic stripe transmission (MST), a global navigation satellite system (GNSS), or the like.

The GNSS may include at least one of a global positioning system (GPS), a global navigation satellite system (Glonass), Beidou Navigation Satellite System (hereinafter referred to as “Beidou”), or the European global satellite-based navigation system (Galileo). In this specification, “GPS” and “GNSS” may be interchangeably used. The wired communication interface may include at least one of, for example, a universal serial bus (USB), a high definition multimedia interface (HDMI), a recommended standard-232 (RS-232), a plain old telephone service (POTS), or the like.

According to an embodiment, the communication interface 170 may send image data, which is pre-processed by applying an optimal frequency or mask filter coefficient corresponding to a designated target bitrate to a low pass filter, to the external electronic device 101 over the network 162. The communication interface 170 may collect information about a wireless network situation, for example, base station system information including parameter information for detecting a wireless environment, wireless signal reception intensity information, or the like. The collected information may be provided to the processor 120.

The image collection sensor 180 may be a sensor that collects image data of the electronic device 100. For example, the image collection sensor 180 may include at least one of a camera disposed on a front surface of the electronic device 100 or a camera disposed on a rear surface thereof. The image collection sensor 180 may collect image data based on a user input and send the collected image data to the display 160 or the memory 130. The image data sent to the display 160 may be outputted as a preview image. The image data sent to the memory 130 may be stored at a designated location. The image data that the image collection sensor 180 collects may be pre-processed automatically according to the amount of available free space in the memory 130 or according to a user selection. The pre-processed image data may be filtered by a low pass filter to which an optimal frequency or mask filter coefficient corresponding to a designated target bitrate is applied.

The encoder 190 may encode the image data that the image collection sensor 180 collects. Alternatively, the encoder 190 may encode the pre-processed image data. According to an embodiment, the encoder 190 may encode the image data, which is stored in the memory 130 and is associated with a streaming service, and send the encoded image data to the communication interface 170. Alternatively, the encoder 190 may encode the pre-processed image data based on an available network bandwidth and send the encoded image data to the communication interface 170. According to various embodiments, for example, the encoder 190 may be implemented to be included in at least a part of the processor 120 or may be implemented by a set of instructions executed by the processor 120.

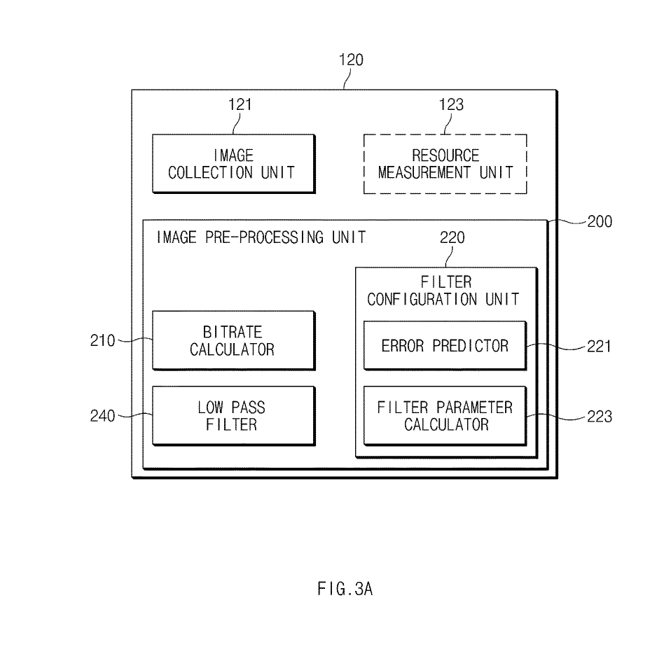

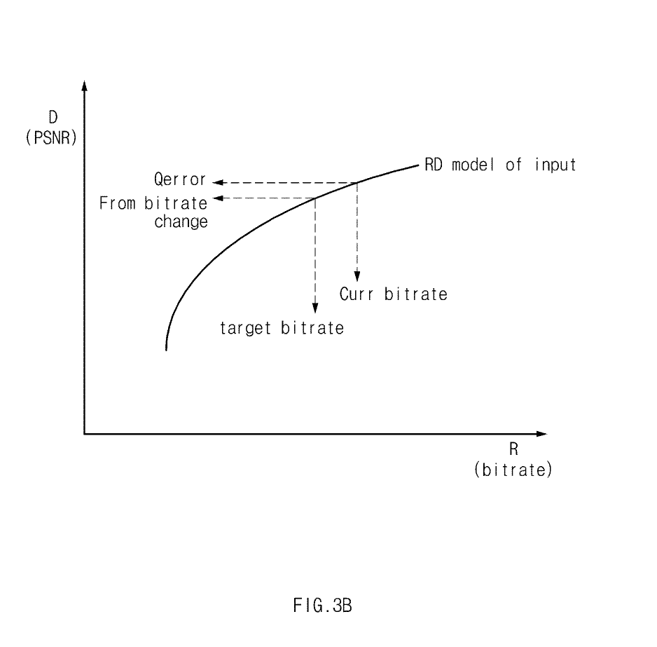

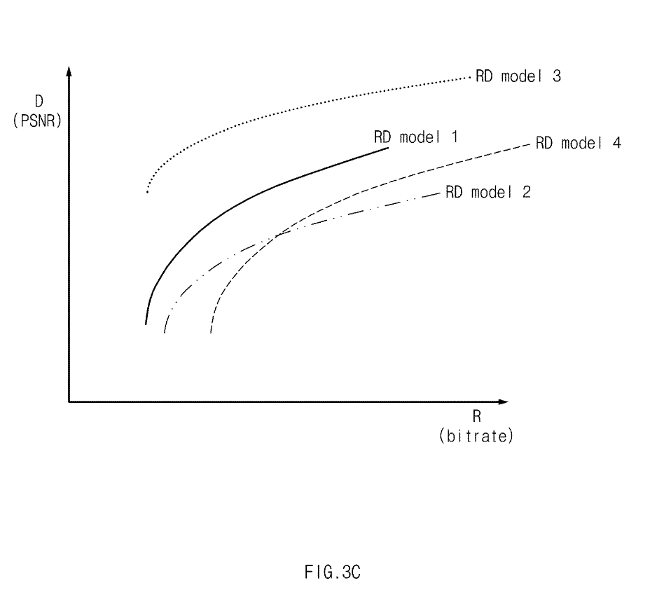

FIG. 3A is a diagram of an example of a processor 120, according to an embodiment. As illustrated, the processor 120 may include an image collection unit 121, a resource measurement unit 123, and an image pre-processing unit 200. According to various embodiments, the resource measurement unit 123 may be an element included in, for example, the communication interface 170.

When the image collection sensor 180 is activated by a user input, the image collection unit 121 may collect image data that the image collection sensor 180 captures. The image collection unit 121 may send the collected image data to the image pre-processing unit 200 under the control of the processor 120. According to an embodiment, an image that the image collection sensor 180 sends may be sent to the image pre-processing unit 200 based on the amount of free space in the memory 130. If the amount of free space in the memory 130 is greater than or equal to a designated threshold, the collected image may be stored in a designated location of the memory 130.

According to various embodiments, the image collection unit 121 may collect image data, which is included in specific video content stored in the memory 130, with regard to an operation of a streaming service. The image collection unit 121 may send the collected image data to the image pre-processing unit 200 based on a characteristic of a network environment that is used to transmit the collected image data. For example, if the amount of available network bandwidth for sending the image data is smaller than or equal to a designated threshold, the image collection unit 121 may send the image data to the image pre-processing unit 200. If the amount of available network bandwidth is greater than or equal to the designated threshold, the image collection unit 121 may send the image data to the communication interface 170. According to aspects of the disclosure, the image collection unit 121 may selectively send image data to the image pre-processing unit 200 based on the amount of free space in the memory 130 and/or the amount of available network bandwidth. However, various embodiments are not limited thereto. For example, the image collection unit 121 may send the collected image data to the image pre-processing unit 200 by default.

The resource measurement unit 123 may detect whether a designated condition would be satisfied if image pre-processing is performed. For example, when image data is stored, the resource measurement unit 123 may detect whether the amount of free space in the memory 130 is greater than or equal to a designated threshold (e.g., a designated size). If the amount of free space is smaller than or equal to a designated threshold, the resource measurement unit 123 may send corresponding status information to the image pre-processing unit 200. Furthermore, when the resource measurement unit 123 performs an image data streaming service, the resource measurement unit 123 may determine the amount of available network bandwidth. According to an embodiment, the resource measurement unit 123 may measure the amount of available network bandwidth based on network status information received from a system and a separate measurement module. The network status information may be verified based on data throughput information of a socket that a communication protocol between a client and a server use, information about a network response speed of an acknowledge (ACK), a round trip time (RTT), and the like in a protocol stack or the like. The resource measurement unit 123 may calculate the available network bandwidth based on a measurement ratio of a request frequency for each client associated with the communication protocol during a designated time. According to various embodiments, the resource measurement unit 123 may use a ratio of a network bandwidth, which is used to transmit image data, to the whole available network bandwidth from a heuristic system model, as a basis for determining whether to perform image pre-processing. If the amount of available network bandwidth is smaller than or equal to a designated threshold, the resource measurement unit 123 may send corresponding status information to the image pre-processing unit 200.

The image pre-processing unit 200 may perform image pre-processing with respect to image data, which the image collection unit 121 sends, under a designated condition. According to an embodiment, if the amount of free space in the memory 130 is smaller than or equal to a designated threshold or if the amount of available network bandwidth is smaller than or equal to a designated threshold, the image pre-processing unit 200 may perform low pass filtering in which an optimal frequency or mask filter coefficient corresponding to a designated target bitrate or the characteristic of image data to be stored is applied to a low pass filter. According to an embodiment, if the amount of free space in the memory 130 is greater than or equal to a designated threshold or if the amount of available network bandwidth is greater than or equal to a designated threshold, the image pre-processing unit 200 may send the collected image data to the encoder 190 without performing separate image pre-processing. The image pre-processing unit 200 may include a bitrate calculator 210, a filter configuration unit 220, and a low pass filter 240.

The bitrate calculator 210 may calculate a target bitrate based on a ratio of the size of image data to the size of the whole data from a data transmission history. Alternatively, according to an embodiment, the bitrate calculator 210 may calculate a designated target bitrate based on the amount of free space in the memory 130. According to various embodiments, the bitrate calculator 210 may calculate a target bitrate based on the ratio of the image data received from a heuristic system model (i.e., a model obtained by modeling optimized bitrate values based on a frequency distribution characteristic of a variety of image data).

The filter configuration unit 220 may apply an optimal frequency or mask filter coefficient corresponding to a target bitrate, which the bitrate calculator 210 calculates, to a filter. In this regard, the filter configuration unit 220 may include an error predictor 221 and a filter parameter calculator 223.

The error predictor 221 may predict an error by calculating a difference between the values of a quality metric such as a peak signal to noise ratio (PSNR) corresponding to a current bitrate and a target bitrate from an RD model of an input source such as the image collection sensor 180. The RD model may be provided as a single model. Additionally or alternatively, in the RD model, pieces of image data may be classified into some groups by using characteristic information of pieces of image data, and pieces of optimized model information may be provided to the divided image data groups.

The filter parameter calculator 223 may apply, to a filter, an optimal frequency (or an optimal threshold frequency) or mask filter coefficient corresponding to an error value predicted by using designated heuristic model information. For example, the heuristic model information may be modeled by performing an image quality evaluation (e.g., a subjective image quality evaluation, image data of which a specific value of a blocking artifact is smaller than or equal to a fixed value) with respect to significant sample image data to which quantization errors of all possible combinations or optimal frequencies (or threshold frequencies) or mask filter coefficients of the low pass filter 240 are applied.

The filter parameter calculator 223 may detect an optimal parameter of a filter such as a cutoff frequency (or an optimal threshold frequency), which corresponds to an expected quantization error, on a frequency domain of a low pass filter, a mask filter coefficient on a pixel domain, or the like from the designated heuristic model information. According to various embodiments, when the electronic device 100 is provided with a high-performance resizer in place of a high-performance low pass filter (e.g., an H/W low pass filter), the electronic device 100 may perform low pass filtering by using the resizer. For example, when a full high definition (FHD) image is received, a high frequency component of the input image may be removed by downsizing the input image to a high definition (HD) level and then upsizing the downsized image to the FHD level. The amount of removed high frequency components may be proportional to a difference between an original image size and a target image size. As described above, when the resizer is operated to perform downsizing and upsizing, the low pass filter may be viewed as a down/up-sizing resizer, and a filter parameter may be viewed as a target image size.

For example, the heuristic model information may be modeled by performing an image quality evaluation (e.g., a mean opinion score (MOS), image data in which a specific value corresponding to a blocking artifact is smaller than or equal to a fixed value) with respect to significant sample image data to which the optimal filter parameter values of the low pass filter 240 and quantization errors of all combinations that the electronic device 100 supports are applied.

Model information that is applied to the error prediction value and model information used to detect the optimal frequency or mask filter coefficient may be provided as a single model or may be provided as a plurality of model information distinguished for respective designated categories. The categories may be classified based on frequency characteristics of pieces of image data. For example, the categories may include an image category having pixels corresponding to a first range of high band frequency values, an image category having pixels corresponding to a first range of low band frequency values, and the like.

According to an embodiment, the error predictor 221 and the filter parameter calculator 223 may operate as one module based on a model obtained by integrating an RD model with an optimized model between a quantization error value and an optimal frequency.

The low pass filter 240 may receive the selected optimal frequency or mask filter coefficient from the filter parameter calculator 223. The low pass filter 240 may perform low pass filtering with respect to input image data received from an input source such as a camera or the like and send the filtered image data to the encoder 190. The filtering may be performed based on at least one of the selected frequency or mask filter. The low pass filtering may minimize a blocking artifact by optimizing the amount of details information and a coding error of a lost image.

As described above, the electronic device 100 may calculate a target bitrate based on resource information measured by the resource measurement unit 123 and apply the optimal frequency or the mask filter coefficient corresponding to the calculated target bitrate to the low pass filter 240. As such, the electronic device 100 may optimize bits allocated to process low frequency band information (or high frequency band information), thereby minimizing degradation of subjective image quality due to the presence of blocking artifacts. The optimal frequency or mask filter coefficient may be selected by calculating a signal to noise ratio (SNR) by using a target bitrate and an RD model of an input source such as a camera and obtaining a proper value from a correlation model between a quantization error corresponding to the calculated SNR and the optimal frequency.

FIG. 3B is a graph illustrating an example of an RD model, according to an embodiment.

Referring to FIG. 3B, R-axis of the RD model represents a bitrate value. D-axis of the RD model represents a PSNR. The RD model illustrated in FIG. 3B may be calculated from an accumulated and uniformed modeling based on pieces of sample image data. For example, in the RD model, a curve has high curvature at a starting point and has a smooth curvature toward an R-axis direction. If a current bitrate (Curr bitrate) is changed to a target bitrate, the PSNR value may be detected according to the RD model as a quantization error value. The filter configuration unit 220 may send the quantization error value selected based on the above-described RD model and an optimal frequency or a mask filter coefficient to the low pass filter 240.

FIG. 3C is a graph illustrating an example of a plurality of RD models, according to an embodiment. As illustrated, RD models (i.e., RD model 1, RD model 2, RD model 3, and RD model 4) are provided. The RD models (i.e., RD model 1, RD model 2, RD model 3, and RD model 4) may be provided as a plurality of model information optimized with respect to pieces of image data classified into several groups based on characteristic(s) of the image data. Classification into the groups may be made based on the information change between a previous frame and a current frame when the change of a target bitrate is requested with the singular or plural previous frame stored therein. For example, the electronic device 100 may quantify the degree of motion, the degree of global motion such as the rotation of a camera, or the degree of detail of the current frame by determining the motion of an object based on an image difference between a previous frame and the current frame. The electronic device 100 may set pieces of the quantified information to steps according to a designated degree and operate the RD models (i.e., RD model 1, RD model 2, RD model 3, and RD model 4) distinguished by classifying categories into the steps or combinations of steps.

As illustrated in FIG. 3C, the electronic device 100 may operate a variety of RD models (i.e., RD model 1, RD model 2, RD model 3, and RD model 4) based on the degree of motion, the degree of global motion, or the degree of detail. According to various embodiments, the electronic device 100 may use any suitable number of models, according to trade-off between accuracy of the change of image data and the computing power of the electronic device 100.

For example, the motion of an object in the image may be measured as the sum of magnitudes of motion vectors with respect to the whole frame after dividing a frame into blocks having a designated size (e.g., a size that is statistically selected) and estimating the motion with respect to each block. Alternatively, the electronic device 100 may measure object motion in the image by using the greatest one of sums of motion vectors or a sum of some thereof. Alternatively, after searching for an edge in the image to distinguish an object, the electronic device 100 may measure the object motion in the image by estimating the motion of each object. Alternatively, the electronic device 100 may measure the object motion in the image by using a combination of the methods.

The global motion may be measured by using a mean of motion vectors that are estimated with respect to the whole frame or blocks obtained by dividing the whole frame. The degree of the detail may be measured by using the magnitude of a high frequency component after transforming the whole frame or each of the blocks of the whole frame so as to be converted into a frequency domain. Alternatively, the degree of the detail may be measured by using the sum of differences between pixels and a DC value measured by calculating an average value of pixels in each block. Alternatively, the degree of the detail may be measured using a wavelet transform method or the like based on the magnitude of a high frequency component with respect to the whole frame without dividing the whole frame into blocks.

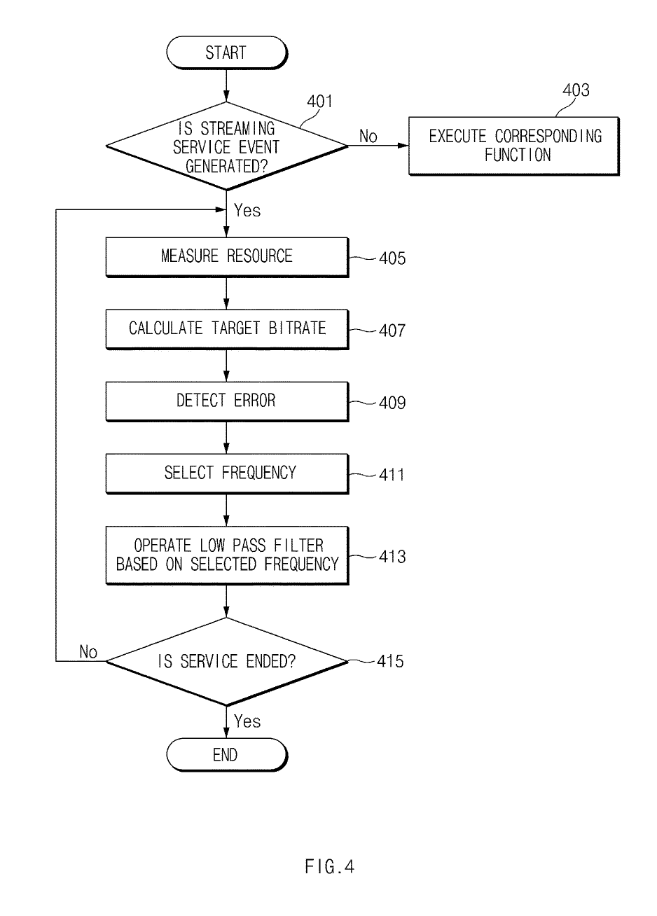

FIG. 4 is a flowchart of an example of a process, according to an embodiment. According to the process, if a specific event is generated, in operation 401, the electronic device 100 (e.g., the processor 120) may detect whether the event is associated with the operation of a streaming service. In this regard, the electronic device 100 may provide a user with an icon or menu item associated with the operation of the streaming service. Alternatively, the electronic device 100 (e.g., the communication interface 170) may receive a streaming service request from the external electronic device 101.

If the specific event does not correspond to an event associated with the streaming service, in operation 403, the electronic device 100 (e.g., the processor 120) may execute a function based on the event's type. For example, based on the type of the event, the electronic device 100 may initiate a telephone call, perform an image edit function, perform a web surfing function, and the like.

If the designated event associated with the streaming service is generated, in operation 405, the electronic device 100 (e.g., the resource measurement unit 123) may obtain a resource characteristic. For example, the electronic device 100 may determine the amount of available network bandwidth based on a current network operation environment. In this regard, the electronic device 100 may receive information associated with determining the available network bandwidth from a system (e.g., a base station).

In operation 407, the electronic device 100 (e.g., the bitrate calculator 210) may calculate a target bitrate. The electronic device 100 may calculate the target bitrate based on an extent to which the available network bandwidth is used up by the transmission of the image data. In operation 409, the electronic device 100 may detect an error that is associated with the target bit rate. If the target bitrate is determined, the electronic device 100 may detect a quantization error based on the determined target bitrate. In operation 411, the electronic device 100 (e.g., the filter configuration unit 220) may select a filtering frequency (e.g., cutoff frequency) or a mask filter coefficient. The electronic device 100 may detect a quantization error and an optimal frequency or mask filter coefficient based on an RD model. Although in the present example, a filtering frequency and/or a mask filter coefficient are selected in operation 411, any suitable type of filter parameter may be obtained instead.

In operation 413, the electronic device may apply a filter to image data that is received from the image collection unit 121 and/or the memory 130. The filter may be applied after the bitrate of the image data is reduced to the target bitrate. The filter may be configured in accordance with the filter parameter that is obtained at operation 411. More particularly, the electronic device 100 (e.g., the filter configuration unit 220) may operate the low pass filter 240 based on the optimal frequency or mask filter coefficient.

For example, the electronic device 100 may determine the number of bits allocated to a low frequency band or the number of bits allocated to a high frequency band based on the optimal frequency or mask filter coefficient. According to an embodiment, to minimize the blocking artifact, the optimal frequency or mask filter coefficient may be determined such that the number of bits allocated to the relatively low frequency band is relatively great. According to various embodiments, to minimize the blocking artifact, the optimal frequency or mask filter coefficient may be determined such that the number of bits allocated to the relatively high frequency band is relatively small compared with the number of bits previously allocated.

The electronic device 100 may send image data, which is filtered by the low pass filter 240, to the encoder 190 and encode the filtered image data. Afterwards, the electronic device 100 may send the encoded image data to the external electronic device 101 or the like through the network 162.

In operation 415, the electronic device 100 (e.g., the processor 120) may detect whether an event associated with a service end (e.g., an image data transmission service) is generated. If the event associated with the service end is generated, the electronic device 100 may transition to a designated state (e.g., a home screen output state, a sleep state, or the like). If the event associated with the service end is not generated, the electronic device 100 may proceed to operation 405 to repeat the above-described operations.

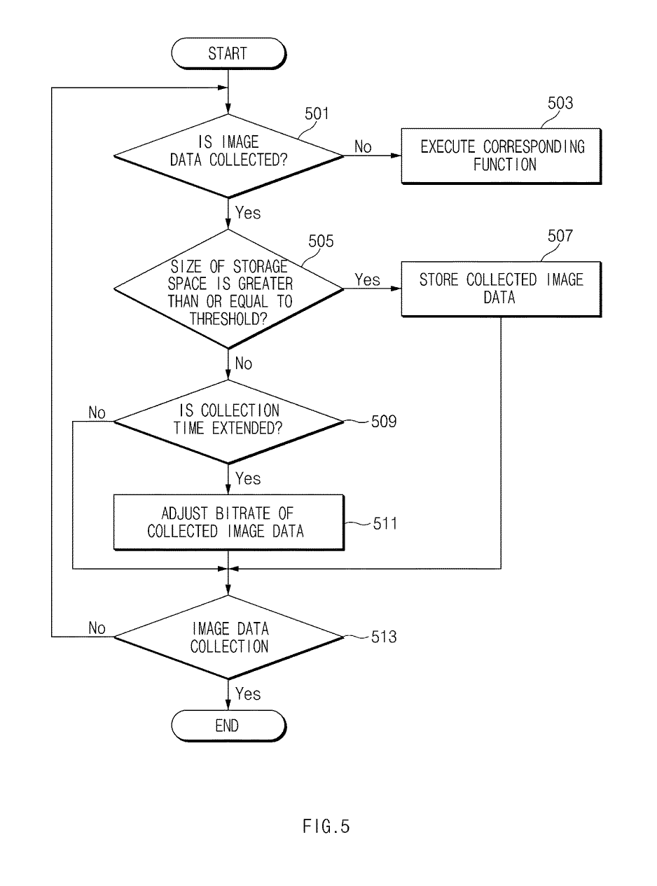

FIG. 5 is a flowchart of an example of a process, according to an embodiment. According to the process, if a specific event is generated, in operation 501, the electronic device 100 (e.g., the image collection unit 121) may detect whether the generated event is an event associated with image data collection. As such, the electronic device 100 may provide a user with an icon or menu item associated with the activation of the image collection sensor 180. Alternatively, the electronic device 100 may receive a signal for requesting the activation of the image collection sensor 180. If the event is not associated with image data collection, in operation 503, the electronic device 100 may execute a function based on the type of the event. For example, the electronic device 100 may execute a web connection function, an image editing function, and the like based on the type of the event.

If the event is associated with the collection of image data, in operation 505, the electronic device 100 (e.g., the resource measurement unit 123) may detect whether the amount of free space in the memory 130 is greater than or equal to a designated threshold. If the amount of free space in the memory is greater than or equal to a designated threshold, in operation 507, the electronic device 100 (e.g., the processor 120) may store collected image data in the memory 130.

If the amount of free space in the memory is smaller than or equal to the designated threshold, in operation 509, the electronic device 100 (e.g., the processor 120) may detect whether an event associated with an image data collection time extension is generated. In this regard, the electronic device 100 may output a notification informing the user that the amount of free space in the memory 130 is smaller than or equal to a threshold. According to various embodiments, the electronic device 100 (e.g., the processor 120) may output a popup window for selecting the image data collection time extension.

If an input event for selecting the collection time extension is generated, in operation 511, the electronic device 100 (e.g., the filter configuration unit 220) may reduce the bit rate of the collected image data to a target bit rate and apply a filter to the collected image data based on the target bitrate. After the bitrate of the image data is lowered and the image data is filtered, the electronic device 100 may store the image data in the memory 130.

According to various embodiments, if the size of a left memory capacity of the memory 130 is smaller than or equal to a threshold, based on a designated setting, the electronic device 100 (e.g., filter configuration unit 220) may proceed to operation 511 to apply an optimal frequency to image data based on the target bitrate and to store the image data in the memory 130. In this operation, the electronic device 100 (or the processor 120) may output guide information for notifying a user of the storage image data according to the applying of the optimal frequency and the collection time extension. If there is no automatic setting associated with the collection time extension or if an input event that is not associated with selection of the collection time extension is received, the electronic device 100 may skip operation 511.

In operation 513, the electronic device 100 (e.g., the processor 120) may detect whether an end event of an image data processing function is generated. For example, when there is no more free space left in the memory 130 for storing collected image data, the electronic device 100 may determine that an end event is generated. In this case, the electronic device 100 may end an image data collection function and output guide information about the lack of the storage space. If the event associated with a separate function end is not generated, the electronic device 100 may proceed to operation 501 to repeat the above-described operations. According to various embodiments, even though the event associated with the separate function end is not generated, the electronic device 100 (e.g., the resource measurement unit 123) may detect whether the size of the amount of free space in the memory 130 is smaller than or equal to another threshold after storing data according to the applying of the optimal frequency or mask filter coefficient. If the size of a left space of the memory 130 is smaller than or equal to the threshold, the electronic device 100 may output guide information about the lack of the storage space. If the amount of free space in the memory 130 is smaller than or equal to another threshold, the electronic device 100 may notify a user of the lack of space in the memory 130 and end a function.

According to various embodiments, an image data processing method may include detecting a data transmission rate in which the communication circuit (or a communication interface or communication module, or communication circuitry) sends the image data, in a current wireless environment, generating change data by decreasing a size of data, which belongs to a high frequency band, in the image data if the data transmission rate is smaller than or equal to a value, and transmitting the change data.

According to various embodiments, the method may further include calculating a target bitrate corresponding to the data transmission rate.

According to various embodiments, the generating of the change data may include selecting a parameter of a filter that processes the image data based on the target bitrate and generating the change data based on the selected parameter of the filter.

According to various embodiments, the generating of the change data may further include applying a parameter in which a blocking artifact is minimized when the image data is encoded.

According to various embodiments, the generating of the change data may further include selecting a parameter in which an artifact is minimized according to an image characteristic of the image data when the image data is encoded based on the target bitrate.

According to various embodiments, the generating of the change data may further include filtering the image data after applying the parameter to the filter such that a number of bits, which are allocated to a relatively high frequency band, from among bits allocated in a quantization process with respect to the image data decreases or such that a number of bits, which are allocated to a relatively low frequency band, from among bits allocated in the quantization process with respect to the image data increases.

According to various embodiments, the generating of the change data may include selecting a parameter, in which an artifact is minimized according to an image characteristic of the image data when the image data is encoded based on the target bitrate, in a lookup table.

According to various embodiments, the generating of the change data may include selecting the parameter based on an RD model, which is associated with the target bitrate, from among a plurality of RD models stored in the memory or selecting an RD model, which corresponds to a degree of a motion difference between a previous frame and a current frame of the image data, a degree of detail of the current frame, or a degree of global motion included in the image data, from among the plurality of RD models.

According to various embodiments, the sending of the change data may include sending the image data in a streaming manner.

According to various embodiments, an image data processing method according to an embodiment may include collecting resource information associated with image data processing, determining a target bitrate based on the resource information, and storing or sending change data (or change data of which the amount data belonging to a relatively high frequency band in image data decreases to be smaller than the amount data belonging to a relatively high frequency band in previous image data) of which the amount data belonging to a relatively low frequency band in image data increases based on the determined target bitrate to be greater than the amount data belonging to a relatively low frequency band in previous image data.

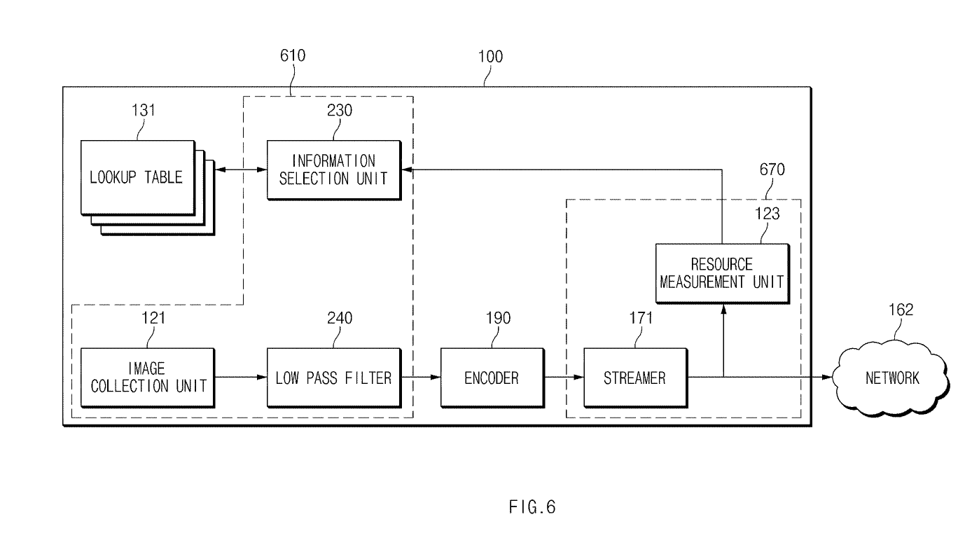

FIG. 6 is diagram of an example of an electronic device 100, according to an embodiment. As illustrated, the electronic device 100 may include an image data processing unit 610, a lookup table 131, the encoder 190, and a communication processing module 670. According to various embodiments, the electronic device 100 may further include a camera that is capable of collecting image data, a memory that is capable of storing the image data, and the like.

For example, the image data processing unit 610 may be implemented with at least one processor. Alternatively, at least one processor may include the image data processing unit 610. The image data processing unit 610 may include the image collection unit 121, an information selection unit 230, and the low pass filter 240.

The image collection unit 121 may execute a function that is the same as or similar to the image collection unit described in FIG. 3. For example, the image collection unit 121 may collect (e.g., retrieve) image data stored in the memory 130. Alternatively, the image collection unit 121 may obtain image data that that is captured by the image collection sensor 180.

In operation, the information selection unit 230 may select an optimal frequency or mask filter coefficient stored in the lookup table 131. In this operation, the information selection unit 230 may respectively select a specific optimal frequency or mask filter coefficient among a plurality of optimal frequencies or mask filter coefficients stored in the lookup table 131 based on resource information that is provided by the resource measurement unit 123. The information selection unit 230 may provide the selected optimal frequency or mask filter coefficient to the low pass filter 240. According to various embodiments, the information selection unit 230 may execute an optimal frequency or mask filter coefficient calculation function according to operations of the bitrate calculator, the error predictor, and the filter parameter calculator described in FIG. 3.

The low pass filter 240 may apply an optimal frequency or mask filter coefficient, which the information selection unit 230 provides, to an image to filter the image data that the image collection unit 121 provides. For example, the low pass filter 240 may determine an allocation bit of a low frequency band corresponding to an inputted optimal frequency or mask filter coefficient (e.g., increase a bit allocation ratio of a low frequency band) and send image data, in which a blocking artifact is minimized, to the encoder 190.

The encoder 190 may encode the image data that the low pass filter 240 sends. The encoder 190 may send the encoded image data to a streamer 171 of the communication processing module 670.

The communication processing module 670 may include, for example, the streamer 171 and the resource measurement unit 123. The streamer 171 may send the image data, which the encoder 190 sends, to the network 162. In this operation, the streamer 171 may control the image data such that the image data is sent in a streaming manner. The resource measurement unit 123 may collect information about a network environment during an operation of a streaming service of the streamer 171. For example, the resource measurement unit 123 may collect resource information about an available network bandwidth associated with image data transmission. The resource measurement unit 123 may send the collected resource information to the information selection unit 230.

According to various embodiments, while some of elements of the electronic device 100 store image data collected by the image collection sensor 180, the resource measurement unit 123 may measure a resource associated with the remaining free space in the memory 130. The information selection unit 230 may select an optimal frequency or mask filter coefficient of the lookup table 131 based on the resource information associated with the memory 130.

The lookup table 131 may include one or more target bitrates for optimizing image data. Each target bitrate may be associated with one or more of a respective bandwidth, respective quantization error corresponding to the target bitrate, a filter parameter associated with the target bit rate, such as a filtering frequency (e.g., a cutoff frequency) or a mask. According to an embodiment, the lookup table 131 may have optimal frequencies or mask filter coefficients for respective image data divided according to a frequency characteristic included in the image data. For example, the divided image data may include image data that includes data which has relatively high frequency components and of which a size is a fixed size or more, image data that includes data which has relatively low frequency components and of which a size is a fixed size or more, and the like. According to various embodiments, the lookup table 131 may include a model created to indicate designated target bitrates calculated from pieces of sample image data, quantization error values, and values of an optimal frequency or mask filter coefficient. The optimal frequency or mask filter coefficient of the lookup table 131 may correspond to a value of the RD model generated based on subjective image quality evaluation in which a blocking artifact is minimized.

The electronic device 100 may perform image processing without the burden associated with calculating (e.g., calculating a target bitrate with respect to available network bandwidth for each image data, calculating the value of a quantization error with respect to the target bitrate, and calculating an optimal frequency or mask filter coefficient with respect to a quantization error value) of an optimal frequency or mask filter coefficient associated with resource information based on an optimal frequency or mask filter coefficient stored in the lookup table 131. According to various embodiments, the electronic device 100 may directly execute the following: an operation of calculating a target bitrate with respect to available network bandwidth for each image data, an operation of calculating the value of a quantization error with respect to the target bitrate, and an operation calculating an optimal frequency or mask filter coefficient with respect to a quantization error value.

According to various embodiments, an electronic device may include a communication circuit, a memory configured to store image data, and a processor electrically connected to the communication circuit and the memory. The memory may store instructions, the instructions, when executed by the processor, causing the processor to detect a data transmission rate in which the communication circuit sends the image data, to generate change data by decreasing a size of data, which belongs to a high frequency band, in the image data if the data transmission rate is smaller than or equal to a value, and to send the change data through the communication circuit.

According to various embodiments, the memory may further store instructions, the instructions, when executed by the processor, causing the processor to calculate a target bitrate corresponding to the data transmission rate.

According to various embodiments, the memory may further store instructions, the instructions, when executed by the processor, causing the processor to select a parameter of a filter that processes the image data based on the target bitrate and to generate the change data based on the parameter of the selected filter.

According to various embodiments, the memory may further store instructions, the instructions, when executed by the processor, causing the processor to apply the parameter, in which a blocking artifact is minimized in encoding the image data, to the image data.

According to various embodiments, the memory may further store instructions, the instructions, when executed by the processor, causing the processor to select a parameter in which an artifact is minimized according to an image characteristic of the image data when encoding the image data based on the target bitrate.

According to various embodiments, the memory may further store instructions, the instructions, when executed by the processor, causing the processor to filter the image data after applying the parameter to the filter such that a number of bits, which are allocated to a relatively high frequency band, from among bits allocated in a quantization process with respect to the image data decreases or such that a number of bits, which are allocated to a relatively low frequency band, from among bits allocated in the quantization process with respect to the image data increases.

According to various embodiments, the memory may further store instructions, the instructions, when executed by the processor, causing the processor to select a parameter, in which an artifact is minimized according to an image characteristic of the image data when encoding the image data based on the target bitrate, in a lookup table.

According to various embodiments, the memory may further store instructions, the instructions, when executed by the processor, causing the processor to select the parameter based on an RD model, which is associated with the target bitrate, from among a plurality of RD models stored in the memory.

According to various embodiments, the memory may further store instructions, the instructions, when executed by the processor, causing the processor to select an RD model, which corresponds to a degree of a motion difference between a previous frame and a current frame of the image data, a degree of detail of the current frame, or a degree of global motion included in the image data, from among the plurality of RD models.

According to various embodiments, the memory may further store instructions, the instructions, when executed by the processor, causing the processor to send the image data in a streaming manner.

In accordance with an aspect of the present disclosure, an electronic device may include a communication circuit, a memory configured to temporarily store image data, and a processor electrically connected to the communication circuit and the memory. The memory may store instructions, the instructions, when executed by the processor, causing the processor to detect a data transmission rate in which the communication circuit sends the image data and to send the image data, of which the size of the data belonging to the low frequency band increases based on the data transmission rate (or the image data of which the size of the data belonging to the high frequency band decreases), through the communication circuit.

According to various embodiments, an electronic device according to an embodiment may include a processor and a memory that is functionally connected to the processor and stores at least one instruction executed by the processor. The processor may determine a target bitrate based on the amount of free space in the memory, in which an image that an image collection sensor collects is stored, to store change data (e.g., change data obtained by filtering image data based on an optimal frequency or mask filter coefficient in which a designated artifact of the image data is minimized) of which the amount of data belonging to a low frequency band in image data increases based on the target bitrate to be greater than the amount of data belonging to a low frequency band in previous image data.

According to various embodiments, if the amount of free space in the memory is smaller than or equal to a designated threshold, the processor may determine whether to select image collection time extension.

According to various embodiments, the processor may output image collection time information additionally extending according to the filtering.

According to various embodiments, an electronic device according to an embodiment may include a processor and a memory that is functionally connected to the processor and stores at least one instruction executed by the processor. The processor may be configured to collect resource information associated with image data processing, to determine a target bitrate based on the resource information, and to generate change data (e.g., change data in which the amount of data of a relatively high frequency band in image data decreases to be smaller than the amount of data belonging to a relatively high frequency band in previous image data) of which the amount of data belonging to a relatively low frequency band in image data increases based on the target bitrate to be greater than the amount of data belonging to a relatively low frequency band in previous image data.

According to various embodiments, the processor may collect available network bandwidth information as the resource information in a network environment during the image data transmission.

According to various embodiments, the processor may determine the amount of free space in the memory, in which image data that image collection sensor collects is stored, as the resource information.

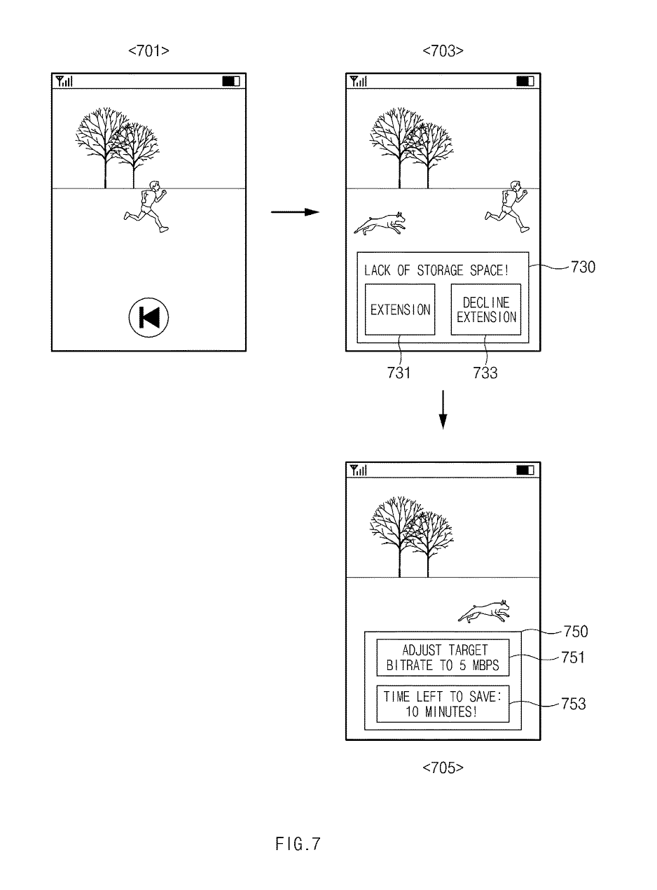

FIG. 7 is a diagram of an example of a user interface, according to an embodiment. As illustrated in state 701, the electronic device 100 (e.g., the image collection unit 121) according to an embodiment may collect a video. In this regard, the electronic device 100 may provide a user with an icon or menu item associated with the operation of the image collection sensor 180. The electronic device 100 may activate the image collection sensor 180 in response to the selection of the corresponding icon or menu item. If there is a video record setting or if an input event is generated, the electronic device 100, may output, to a display, an image, which the image collection sensor 180 collects, as a preview image to store the collected image data to the memory 130.

While image data is stored in the memory 130, the electronic device 100 (e.g., the resource measurement unit 123) may detect whether the size of the storage space of the memory 130 is smaller than or equal to a designated threshold (e.g., whether the amount of free space in the memory 130 is smaller than or equal to a designated threshold). If the amount of free space in the memory 130 is smaller than or equal to a threshold, as illustrated in state 703, the electronic device 100 may output notification 730 indicating the lack of available storage space. The first guide information 730 may include a first virtual button 731 associated with collection time extension and a second virtual button 733 associated with not applying of the collection time extension. If a designated time elapses without one of the virtual buttons being selected, the electronic device 100 may automatically execute a predetermined function. The predetermined function may be one that is normally executed when the first virtual button 731 or the second virtual button 733 is selected.

If the first virtual button 731 is selected, as illustrated in state 705, the electronic device 100 may output second guide information 750 associated with collection time extension. The second guide information 750 may include, for example, a first information item 751 (e.g., notification) for notifying the user of a target bitrate which would be imparted on the image data that is captured by the image sensor 180, and a second information item 753 for notifying the user of a time extension that would be needed in order for the image data to be converted to the target bit rate. In other words, the time extension may indicate a time delay in the storing of the image data in the memory 130 which results from the image data being converted to the target bit rate.

According to aspects of the disclosure, the electronic device 100 may detect an image data characteristic of a collected image data in order to determine a filter parameter (e.g., an optimal frequency or mask filter coefficient). After the bitrate of the image data is reduced to a target bitrate, the image data may be filtered based on the filter parameter in order to reduce the incidence of blocking artifacts in the image data that occur as a result of the bitrate reduction. More particularly, as described above, the electronic device 100 may select an optimal frequency or mask filter coefficient stored in the lookup table 131 to execute an operation associated with the selection of the optimal frequency or mask filter coefficient based on a designated model. If the optimal frequency or mask filter coefficient is selected, the electronic device 100 may apply filtering according to the applying of the selected optimal frequency or mask filter coefficient to image data. Additionally or alternatively, the electronic device 100 may output the first information item 751 corresponding to target bitrate adjustment value applied according to an image characteristic. For example, the electronic device 100 may change a target bitrate, which is set to 10 Mbps, into 5 Mbps to output information corresponding to the changed target bitrate. With the output of the corresponding to information, the electronic device 100 may adjust a target bitrate, which is applied to a collected image, to 5 Mbps.

According to an embodiment, the electronic device 100 may estimate the amount of image data, which the memory 130 is capable of storing in the remaining free space, based on a situation in which filtering image data is encoded and stored according to the applying of the selected optimal frequency or mask filter coefficient. The electronic device 100 may calculate image collection time information extending based on the amount of the estimated image data to output the second information item 753 based on the image collection time information. According to various embodiments, the electronic device 100 may skip the output of the first information item 751 described in state 705 to perform only the output of the second information item 753.

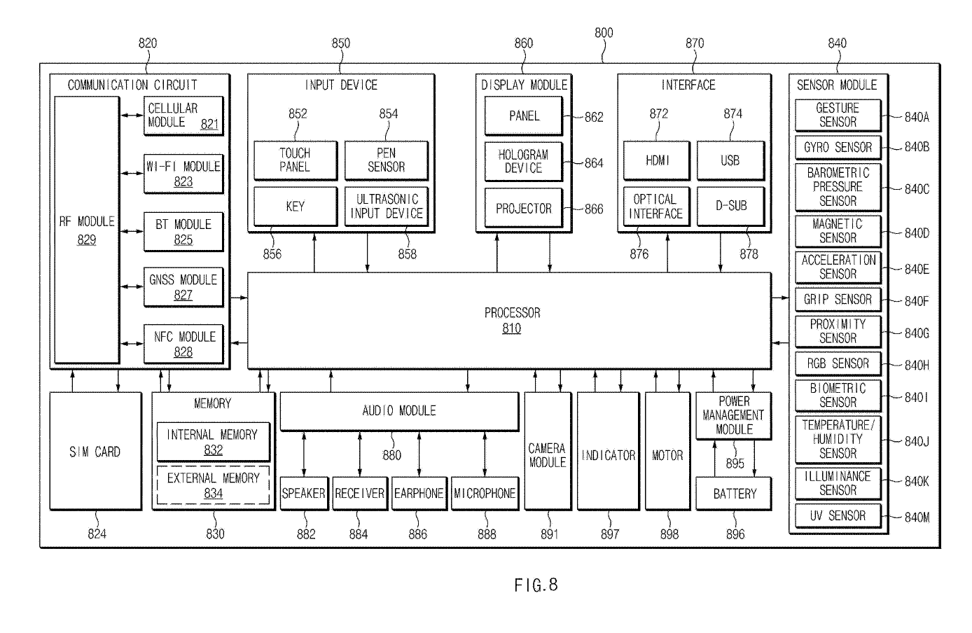

FIG. 8 is a diagram of an example of an electronic device 800, according to an embodiment. As illustrated, the electronic device 800 (e.g., the electronic device 100) may include, for example, all or a part of the electronic device described in above-described various embodiments. The electronic device 800 may include one processor (e.g., an application processor) 810, a communication circuit 820, a subscriber identification module 824, a memory 830, a sensor module 840, an input device 850, a display module 860, an interface 870, an audio module 880, a camera module 891, a power management module 895, a battery 896, an indicator 897, and a motor 898.

The processor 810 (e.g., the main control module 120) may drive an operating system (OS) or an application to control a plurality of hardware or software components connected to the processor 810 and may process and compute a variety of data. For example, the processor 810 may be implemented with a System on Chip (SoC). According to an embodiment, the processor 810 may further include a graphic processing unit (GPU) and/or an image signal processor. The processor 810 may include at least a part (e.g., a cellular module 821) of components illustrated in FIG. 8. The processor 810 may load and process an instruction or data, which is received from at least one of other components (e.g., a nonvolatile memory), and may store a variety of data at a nonvolatile memory.

The communication circuit 820 may include a cellular module 821, a Wi-Fi module 823, a Bluetooth (BT) module 825, a GNSS module 827 (e.g., a GPS module, a Glonass module, a Beidou module, or a Galileo module), a near field communication (NFC) module 828, and a radio frequency (RF) module 829. Additionally, the communication circuit 820 may further include a MST module.

The cellular module 821 may provide voice communication, video communication, a character service, an Internet service, or the like through a communication network. According to an embodiment, the cellular module 821 may perform discrimination and authentication of the electronic device 800 within a communication network using the subscriber identification module 824 (e.g., a SIM card). According to an embodiment, the cellular module 821 may perform at least a portion of functions that the processor 810 provides. According to an embodiment, the cellular module 821 may include a communication processor (CP).

For example, each of the Wi-Fi module 823, the BT module 825, the GNSS module 827, and the NFC module 828 may include a processor for processing data exchanged through a corresponding module. According to an embodiment, at least a part (e.g., two or more components) of the cellular module 821, the Wi-Fi module 823, the BT module 825, the GNSS module 827, and the NFC module 828 may be included within one Integrated Circuit (IC) or an IC package.

For example, the RF module 829 may transmit and receive a communication signal (e.g., an RF signal). For example, the RF module 829 may include a transceiver, a power amplifier module (PAM), a frequency filter, a low noise amplifier (LNA), an antenna, or the like. According to another embodiment, at least one of the cellular module 821, the Wi-Fi module 823, the BT module 825, the GNSS module 827, or the NFC module 828 may transmit and receive an RF signal through a separate RF module.

The subscriber identification module 824 may include, for example, a subscriber identification module and may include unique identify information (e.g., integrated circuit card identifier (ICCID)) or subscriber information (e.g., integrated mobile subscriber identity (IMSI)).

The memory 830 (e.g., the memory 80) may include an internal memory 832 or an external memory 834. For example, the internal memory 832 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, or a NOR flash memory), a hard drive, or a solid state drive (SSD).

The external memory 834 may include a flash drive, for example, compact flash (CF), secure digital (SD), micro secure digital (Micro-SD), mini secure digital (Mini-SD), extreme digital (xD), multimedia card (MMC), a memory stick, or the like. The external memory 834 may be functionally and/or physically connected to the electronic device 800 through various interfaces.

The electronic device may further include a security module. The security module may be a module that includes a storage space of which a security level is higher than that of the memory 830 and may be a circuit that guarantees safe data storage and a protected execution environment. The security module may be implemented with a separate circuit and may include a separate processor. For example, the security module may be in a smart chip or a secure digital (SD) card, which is removable, or may include an embedded secure element (eSE) embedded in a fixed chip of the electronic device 800. Furthermore, the security module may operate based on an operating system (OS) that is different from the OS of the electronic device 800. For example, the security module may operate based on java card open platform (JCOP) OS.

The sensor module 840 may measure, for example, a physical quantity or may detect an operation state of the electronic device 800. The sensor module 940 may convert the measured or detected information to an electric signal. The sensor module 840 may include at least one of a gesture sensor 840A, a gyro sensor 840B, a barometric sensor 840C, a magnetic sensor 840D, an acceleration sensor 840E, a grip sensor 840F, a proximity sensor 840G a color sensor 840H (e.g., red, green, blue (RGB) sensor), a biometric sensor 840I, a temperature/humidity sensor 840J, an illuminance sensor 840K, or an UV sensor 840M. Even though not illustrated, additionally or alternatively, the sensor module 840 may include, for example, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, and/or a fingerprint sensor. The sensor module 840 may further include a control circuit for controlling at least one sensor included therein. According to an embodiment, the electronic device 800 may further include a processor which is a part of the processor 810 or independent of the processor 810 and is configured to control the sensor module 840. The processor may control the sensor module 840 while the processor 810 remains at a sleep state.

The input device 850 may include, for example, a touch panel 852, a (digital) pen sensor 854, a key 856, or an ultrasonic input unit 858. The touch panel 852 may use at least one of capacitive, resistive, infrared and ultrasonic detecting methods. Also, the touch panel 852 may further include a control circuit. The touch panel 852 may further include a tactile layer to provide a tactile reaction to a user.

The (digital) pen sensor 854 may be, for example, a part of a touch panel or may include an additional sheet for recognition. The key 856 may include, for example, a physical button, an optical key, a keypad, or the like. The ultrasonic input device 858 may detect (or sense) an ultrasonic signal, which is generated from an input device, through a microphone (e.g., a microphone 888) and may check data corresponding to the detected ultrasonic signal.

The display 860 (e.g., the display 160) may include a panel 862, a hologram device 864, or a projector 866. The panel 862 may be implemented to be flexible, transparent or wearable, for example. The panel 862 and the touch panel 852 may be integrated into a single module. The hologram device 864 may display a stereoscopic image in a space using a light interference phenomenon. The projector 866 may project light onto a screen so as to display an image. The screen may be arranged in the inside or the outside of the electronic device 800. According to an embodiment, the display module 860 may further include a control circuit for controlling the panel 862, the hologram device 864, or the projector 866.

The interface 870 may include, for example, a high definition multimedia interface (HDMI) 872, a universal serial bus (USB) 874, an optical interface 876, or a D-subminiature (D-sub) 878. Additionally or alternatively, the interface 870 may include, for example, a mobile high definition link (MHL) interface, a SD card/multi-media card (MMC) interface, or an infrared data association (IrDA) standard interface.

The audio module 880 may convert a sound and an electric signal in dual directions. The audio module 880 may process, for example, sound information that is inputted or outputted through a speaker 882, a receiver 884, an earphone 886, or a microphone 888.

The camera module 891 for shooting a still image or a video may include, for example, one image sensor (e.g., a front sensor or a rear sensor), a lens, an image signal processor (ISP), or a flash (e.g., an LED or a xenon lamp)

The power management module 895 may manage, for example, power of the electronic device 800. According to an embodiment, a power management integrated circuit (PMIC), a charger IC, or a battery or fuel gauge may be included in the power management module 895. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of the battery 896 and a voltage, current or temperature thereof while the battery is charged. The battery 896 may include, for example, a rechargeable battery and/or a solar battery.

The indicator 897 may display a specific state of the electronic device 800 or a part thereof (e.g., the processor 810), such as a booting state, a message state, a charging state, and the like. The motor 898 may convert an electrical signal into a mechanical vibration and may generate the following effects: vibration, haptic, and the like. Although not illustrated, a processing device (e.g., a GPU) for supporting a mobile TV may be included in the electronic device 800. The processing device for supporting a mobile TV may process media data according to the standards of DMB, digital video broadcasting (DVB), MediaFlo™, or the like.

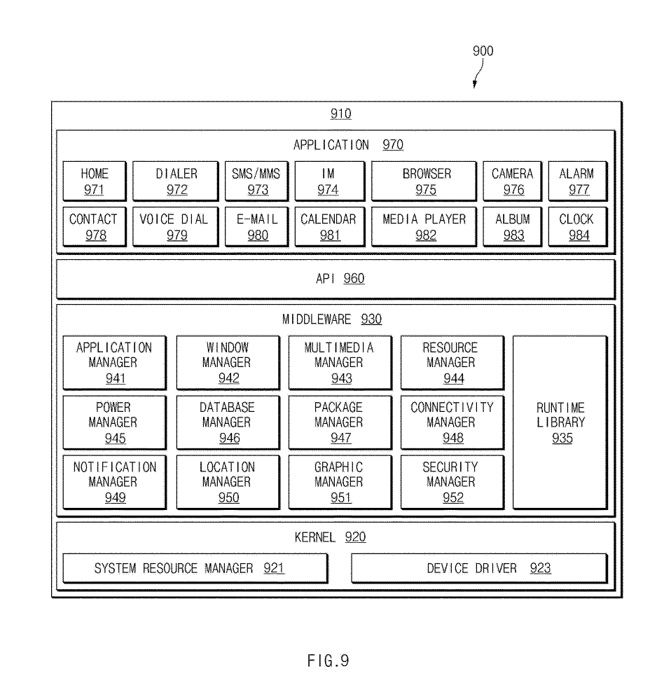

FIG. 9 is a diagram of an example of a program module 910, according to an embodiment. As illustrated, the program module 910 (e.g., the program 140) according to various embodiments may include an operating system (OS) to control resources associated with an electronic device (e.g., the electronic device 100 or the electronic device 800), and/or diverse applications driven on the OS. The OS may be, for example, Android, iOS, Windows, Symbian, Tizen, or Bada.

The program module 910 may include a kernel 920, a middleware 930, an application programming interface (API) 960, and/or an application 970. At least a part of the program module 910 may be preloaded on an electronic device or may be downloadable from an external electronic device.

The kernel 1220 may include, for example, a system resource manager 921 or a device driver 923. The system resource manager 921 may perform control, allocation, or retrieval of system resources. According to an embodiment, the system resource manager 921 may include a process managing unit, a memory managing unit, or a file system managing unit. The device driver 923 may include, for example, a display driver, a camera driver, a Bluetooth driver, a common memory driver, an USB driver, a keypad driver, a Wi-Fi driver, an audio driver, or an inter-process communication (IPC) driver.

The middleware 930 may provide, for example, a function which the application 970 needs in common, or may provide diverse functions to the application 970 through the API 960 to allow the application 970 to efficiently use limited system resources of the electronic device. According to an embodiment, the middleware 930 may include at least one of a runtime library 935, an application manager 941, a window manager 942, a multimedia manager 943, a resource manager 944, a power manager 945, a database manager 946, a package manager 947, a connectivity manager 948, a notification manager 949, a location manager 950, a graphic manager 951, or a security manager 952.

The runtime library 935 may include, for example, a library module which is used by a compiler to add a new function through a programming language while the application 970 is being executed. The runtime library 935 may perform input/output management, memory management, or capacities about arithmetic functions.

The application manager 971 may manage, for example, a life cycle of at least one application of the application 970. The window manager 942 may manage a GUI resource which is used in a screen. The multimedia manager 943 may identify a format necessary for playing diverse media files, and may perform encoding or decoding of media files by using a codec suitable for the format. The resource manager 944 may manage resources such as a storage space, memory, or source code of at least one application of the application 970.

The power manager 945 may operate, for example, with a basic input/output system (BIOS) to manage a battery or power, and may provide power information for an operation of an electronic device. The database manager 946 may generate, search for, or modify database which is to be used in at least one application of the application 970. The package manager 947 may install or update an application which is distributed in the form of package file.

The connectivity manager 948 may manage, for example, wireless connection such as Wi-Fi or Bluetooth. The notification manager 949 may display or notify an event such as arrival message, promise, or proximity notification in a mode that does not disturb a user. The location manager 950 may manage location information of an electronic device. The graphic manager 951 may manage a graphic effect that is provided to a user, or manage a user interface relevant thereto. The security manager 952 may provide a general security function necessary for system security or user authentication. According to an embodiment, when an electronic device (e.g., the electronic device 100) includes a telephony function, the middleware 930 may further include a telephony manager for managing a voice or video call function of the electronic device.

The middleware 930 may include a middleware module that combines diverse functions of the above-described components. The middleware 930 may provide a module specialized to each OS kind to provide differentiated functions. Additionally, the middleware 930 may remove a part of the preexisting components, dynamically, or may add a new component thereto.

The API 960 may be, for example, a set of programming functions and may be provided with another configuration which is variable depending on an OS. For example, when the OS is Android or iOS, it may be permissible to provide one API set per platform. When the OS is Tizen, it may be permissible to provide two or more API sets per platform.

The application 970 may include, for example, one application capable of providing functions for a home 971, a dialer 972, an SMS/MMS 973, an instant message (IM) 974, a browser 975, a camera 976, an alarm 977, a contact 978, a voice dial 979, an e-mail 980, a calendar 981, a media player 982, an album 983, a timepiece 984, and a payment, or for offering health care (e.g., measuring an exercise quantity or blood sugar) or environment information (e.g., atmospheric pressure, humidity, or temperature).

According to an embodiment, the application 970 may include an application (hereinafter referred to as “information exchanging application” for descriptive convenience) to support information exchange between an electronic device (e.g., the electronic device 100) and a server. The information exchanging application may include, for example, a notification relay application for transmitting specific information to the external device, or a device management application for managing an external electronic device or an external device.

For example, the information exchanging application may include a function of transmitting notification information, which is generated from other applications (e.g., applications for SMS/MMS, e-mail, health care, or environmental information), to an external electronic device. Additionally, the information exchanging application may receive, for example, notification information from an external electronic device and provide the notification information to a user.

The device management application may manage (e.g., install, delete, or update), for example, at least one function (e.g., turn-on/turn-off of an external device itself (or a part of components) or adjustment of brightness (or resolution) of a display) of the external electronic device which communicates with an electronic device, an application running in the external electronic device, or a service (e.g., a call service, a message service, or the like) provided from the external device.

According to an embodiment, the application 970 may include an application (e.g., a health care application of a mobile medical device or the like) which is assigned in accordance with an attribute of the external electronic device. According to an embodiment, the application 970 may include an application received from an external electronic device or a server. According to an embodiment, the application 970 may include a preloaded application or a third party application which is downloadable from a server. The component titles of the program module 910 according to the embodiment may be modifiable depending on kinds of operating systems.

According to various embodiments, at least a part of the program module 910 may be implemented by software, firmware, hardware, or a combination of two or more thereof. At least a part of the program module 910 may be implemented (e.g., executed), for example, by a processor. At least a portion of the program module 910 may include, for example, modules, programs, routines, sets of instructions, processes, or the like, for performing one function.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments may be combined with each other so as to form one entity, so that the functions of the elements may be performed in the same manner as before the combination.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments of the present disclosure may be, for example, implemented by instructions stored in a computer-readable storage media in the form of a program module. If the instructions are executed by a processor (e.g., the processor 120), the one processor may perform functions corresponding to the instructions. The computer-readable storage media, for example, may be the memory 130.

A computer-readable recording medium according to various embodiments may include a memory that stores at least one instruction associated with processing of image data. The at least one instruction stored in the memory may cause at least one processor to detect a data transmission rate in which the communication circuit sends the image data, in a current wireless environment, to generate change data by increasing a size of data, which belongs to a low frequency band, in the image data to be greater than a size of data belonging to a low frequency band in previous image data or by decreasing a size of data, which belongs to a high frequency band, in the image data to be smaller than a size of data belonging to a high frequency band in previous image data if the data transmission rate is smaller than or equal to a value and to send the change data through the communication circuit.

A computer-readable recording medium may include a hard disk, a magnetic media, a floppy disk, a magnetic media (e.g., a magnetic tape), an optical media (e.g., a compact disc read only memory (CD-ROM) and a digital versatile disc (DVD), a magneto-optical media (e.g., a floptical disk), and hardware devices (e.g., a read only memory (ROM), a random access memory (RAM), or a flash memory). Also, a program instruction may include not only a mechanical code such as things generated by a compiler but also a high level language code executable on a computer using an interpreter. The above hardware unit may be configured to operate via one software module for performing an operation of the present disclosure, and vice versa.

According to various embodiments of the present disclosure, various embodiments may provide the improved image quality by removing a blocking artifact based on the application of an adaptive prefilter.

Besides, various effects obtained through the specification may be provided.

A module or a program module according to various embodiments of the present disclosure may include at least one of the above elements, or a part of the above elements may be omitted, or additional other elements may be further included. Operations performed by a module, a program module, or other elements according to various embodiments of the present disclosure may be executed sequentially, in parallel, repeatedly, or in a heuristic method. In addition, a part of operations may be executed in different sequences or may be omitted. Alternatively, other operations may be added. While the present disclosure has been shown and described with reference to various embodiments thereof, it will be understood by those skilled in the art that various changes in form and details may be made therein without departing from the spirit and scope of the present disclosure as defined by the appended claims and their equivalents.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

What is claimed is:

1. An electronic device comprising:
a communication circuit;
a memory; and
at least one processor operatively coupled to the memory, configured to:
acquire image data for storage in the memory;
identify a data transmission rate;
in response to detecting that the data transmission rate fails to meet a threshold, apply a filter to the image data to generate filtered data, wherein the filter removes a portion of the image data that is associated with a given frequency band; and
transmitting the filtered data to an external device by using the communication circuit.

2. The electronic device of claim 1, wherein the at least one processor is further configured to calculate a target bitrate corresponding to the data transmission rate.

3. The electronic device of claim 2, wherein the at least one processor is further configured to select a parameter of the filter based on the target bitrate.

4. The electronic device of claim 3, wherein applying the filter causes an incidence of blocking artifacts in the filtered data to be reduced.

5. The electronic device of claim 3, wherein the parameter is selected based on a characteristic of the image data.

6. The electronic device of claim 3, wherein the memory further stores instructions, the instructions, when executed by the processor, causing the processor to filter the image data after applying the parameter to the filter such that a number of bits, which are allocated to a relatively high frequency band, from among bits allocated in a quantization process with respect to the image data decreases or such that a number of bits, which are allocated to a relatively low frequency band, from among bits allocated in the quantization process with respect to the image data increases.

7. The electronic device of claim 3, wherein the parameter is selected based on the target bitrate by using a lookup table that associates different parameter values with respective target bitrates.

8. The electronic device of claim 3, wherein the parameter is selected based on an RD model that is associated with the target bitrate.

9. The electronic device of claim 8, wherein the RD model is selected from a plurality of available RD models based on a characteristic of the image data, the characteristic including at least one of a degree of detail in a current frame of the image data, and a degree of global motion associated with the image data.

10. The electronic device of claim 1, wherein transmitting the filtered data includes streaming the filtered data.

11. A method comprising:
acquiring image data;
identifying a data transmission rate;
in response to detecting that the data transmission rate fails to meet a threshold, applying a filter to the image data to generate filtered data, wherein the filter removes a portion of the image data that is associated with a given frequency band; and
transmitting the filtered data to an external device by using a communication circuit.

12. The method of claim 11, further comprising calculating a target bitrate corresponding to the data transmission rate.

13. The method of claim 12, further comprising selecting a parameter of the filter based on the target bitrate.

14. The method of claim 13, wherein applying the filter causes an incidence of blocking artifacts in the filtered data to be reduced.

15. The method of claim 13, wherein the parameter is selected based on a characteristic of the image data.

16. The method of claim 13, wherein the generating of the change data further comprises:
filtering the image data after applying the parameter to the filter such that a number of bits, which are allocated to a relatively high frequency band, from among bits allocated in a quantization process with respect to the image data decreases or such that a number of bits, which are allocated to a relatively low frequency band, from among bits allocated in the quantization process with respect to the image data increases.

17. The method of claim 13, wherein the parameter is selected based on the target bitrate by using a lookup table that associates different parameter values with respective target bitrates.

18. The method of claim 13, wherein the parameter is selected based on an RD model, the RD model being selected from a plurality of available RD models based on the target bitrate and at least one of at least one of a degree of detail in a current frame of the image data, and a degree of global motion associated with the image data.

19. The method of claim 11, wherein transmitting the filtered data includes streaming the filtered data.

20. A non-transitory computer readable medium storing one or more processor-executable instructions which, when executed by at least one processor, cause the at least one processor to perform a method comprising:
acquiring image data;
identifying a data transmission rate;
in response to detecting that the data transmission rate fails to meet a threshold, applying a filter to the image data to generate filtered data, wherein the filter removes a portion of the image data that is associated with a given frequency band; and
transmitting the filtered data to an external device.
